(19) United States
(12) Patent Application Publication
(10) Pub. No.: US 2015/0360630 A1
(43) Pub. Date: Dec. 17, 2015

(54) METHOD AND SYSTEM FOR SUPPLYING AN AIRCRAFT WITH ELECTRICAL POWER

(71) Applicant: MICROTURBO, Toulouse (FR)

(72) Inventors: Jean-François Rideau, Tournefeuille (FR); Florent Dalmas, Garidech (FR)

(73) Assignee: MICROTURBO, Toulouse (FR)

(21) Appl. No.: 14/763,720

(22) PCT Filed: Jan. 20, 2014
(86) PCT No.: PCT/FR2014/050097

§ 371 Date: Jul. 27, 2015

(30) Foreign Application Priority Data
Jan. 30, 2013 (FR) 1350769

(51) Int. Cl. B60R 16/03; B64D 41/00

(52) U.S. Cl. CPC B60R 16/03; B64D 41/00

(57) ABSTRACT

A method and a system for supplying electrical energy to an aircraft that is equipped with a plurality of loads to be powered, said power supply system comprising a plurality of power sources and an on-board energy management module, the energy management module being electrically connected to said power sources and to said loads to be powered. The energy management module is arranged so as to control a supply of power to at least one of said loads using at least two different power sources in parallel in the event of increased energy requirements, said load being initially powered by a single power source.

### GENERAL TECHNICAL FIELD AND PRIOR ART

The present invention relates to the field of the electrical power supply of an aircraft and, more particularly, to a method and a system for managing the electrical power supply system of an aircraft.

An aircraft conventionally comprises an electrical power supply system to power the various pieces of equipment of the aircraft (mechanical actuators, flight controls, in-seat multimedia systems for passengers, cabin ventilation etc.). From an electrical point of view, a piece of aircraft equipment is considered to be a load which consumes electrical energy.

In order to allow an integrated management of the electrical energy in the electrical power supply system, the loads can be of two possible types: those that are referred to as “essential” loads which are important for the operation of the aircraft (flight controls etc.) and those that are referred to as “non-essential” loads which are less important for the operation of the aircraft (in-seat multimedia systems for passengers, cabin ventilation etc.). The loads are also divided according to the location at which they are installed to be powered by the closest power sources and to avoid, as far as possible, the loss of redundancy and/or functionally connected equipment.

The electrical power supply system conventionally comprises a main source of power which is drawn from the engines of the aircraft which are involved in the propulsion of the aircraft. In other words, an aircraft engine supplies, on the one hand, propulsive power to allow the aircraft to move and, on the other hand, non-propulsive power, which is used as the main source of power for the electrical power supply system.

Over the years, the electrical energy requirements of aircrafts have increased. In addition, when the aircraft engines are running at reduced speed, for example, during landing, the electrical power supply system is sometimes not sufficiently powered, which is a disadvantage and does not allow the supply of power to non-essential loads (in-seat multimedia systems for passengers etc.), which is a disadvantage for the aircraft passengers. An immediate solution for eliminating this disadvantage consists in increasing the speed of the aircraft engines during landing, but this increases the fuel consumption and is not desirable.

FR 2 964 087, by the company TURBOMECA, proposed the use of a main power unit when the engines are not sufficient to fulfil the requirements of the electrical power supply system.

In practice, the non-essential loads are offloaded onto the main power unit, whereas the essential loads are powered by the propulsion engines.

This kind of method for managing the power sources is not optimal since it requires complex offloading algorithms to be used, since the offloading is carried out according to the loads to be powered. The offloading is all the more complex since it must also take into account the conditions of availability of a power source. Indeed, the offloading of the electrical loads must be possible when one or more sources are unavailable. In practice, offloading algorithms of this kind do not allow the largest possible number of electrical loads to be powered.

Furthermore, the loss of a source requires the remaining available source or sources to be capable of powering all of the loads until the end of the flight. As a result, the capacity of each power source must greatly exceed the consumption of the load for which it is responsible, which is a waste of energy and penalises the energy efficiency of the aircraft.

Furthermore, the energy management systems according to the prior art are difficult to use, since there are different offloading modules for the loads requiring a current of more than 15 amperes and the loads requiring a current of less than 15 amperes. The offloading must take into account the compatibilities of the sources with the loads, which is a disadvantage.

### BRIEF DESCRIPTION OF THE INVENTION

In order to eliminate at least some of these disadvantages, the invention relates to a method for supplying electrical energy to an aircraft comprising a plurality of loads to be powered and a power supply system, the power supply system being equipped with a plurality of power sources and an on-board energy management module, a method characterised in that the energy management module controls a power supply to at least one of said loads using at least two different power sources in parallel in the event of increased energy requirements, said load initially being powered by a single power source.

The invention also relates to an electrical energy power supply system of an aircraft that is equipped with a plurality of loads to be powered, said power supply system comprising a plurality of power sources and an on-board energy management module, the energy management module being electrically connected to said power sources and to said loads to be powered, the energy management module being arranged so as to control a supply of power to at least one of said loads using at least two different power sources in parallel in the event of increased energy requirements, said load initially being powered by a single power source.

By means of the invention, a load is powered in a hybrid manner by a plurality of different power sources. Advantageously, it is no longer necessary to offload a load onto another power source if the current power source is not sufficient. This kind of method for supplying power provides great flexibility of use and allows all of the loads to be powered optimally without generating excessive power, which improves the energy efficiency of the aircraft. Furthermore, the management module forms a universal power source which dynamically adapts the energy supply to the demand for electrical energy. The power sources are advantageously shared.

Furthermore, the invention makes it easier to minimise the risk of interruptions to the electrical system.

Furthermore, instead of offloading onto a larger power source, smaller electrical power sources can be accumulated to meet the requirements of the electrical load. In this way, the generation of unnecessary energy and, consequently, the fuel consumption of the aircraft are limited, which improves its energy efficiency.

Preferably, the system comprises means for storing energy, the management module being arranged so as to power at least one of said loads using the means for storing energy in the event of said load to be powered having an urgent energy requirement. Means for storing energy allow an urgent energy requirement to be met without leading to an excessive generation of energy over a long period of time. The storage means allow a one-off energy requirement to be met which was not fulfilled with the offloading methods according to the prior art.

According to a preferred aspect of the invention, the means for storing energy are in the form of an energy cell. A cell of this kind has a compact design and is capable of supplying a large amount of energy quickly.

According to another aspect of the invention, said at least two sources are capable of supplying a direct current to said at least one load.

According to an aspect of the invention, said at least two sources are capable of supplying an alternating current to said at least one load. The use of two sources of alternating current goes against the preconceptions of a person skilled in the art, who believes that the coupling phenomena relating to the sources of alternating current prohibit use in the aeronautical field.

Preferably, the management module comprises means for synchronising the sources of alternating current for simultaneously powering the load in order to limit the coupling phenomena.

Preferably, the energy management module is stand-alone. In other words, the management module is capable of dynamically configuring the connections between the sources and the loads. Preferably, the management module comprises a database comprising specific rules that are capable of selecting the best configuration of the connections according to the state of the sources and the loads.

Preferably, the energy management module is configured so as to adapt the connections of the power sources according to the current consumed by the loads over time. Thus, the generation of energy by the sources is adapted to the consumption of the loads.

Preferably, the energy management module is configured so as to command an increase in the generation of energy of one of the sources powering the load if the consumption of the load increases.

Preferably, the system comprises at least one auxiliary power supply module which is electrically connected to the management module and to said plurality of loads, the energy management module being capable of directly powering the high-power loads and of indirectly powering the low and medium-power loads via said auxiliary power supply module. The management module controls the high-power power supply and delegates the power supply of the medium and low-power loads to an auxiliary module which performs the adaptation of the current required by the loads. This kind of power supply architecture allows the quality of the current supplied to be improved whilst increasing the reliability of the power supply. In this example, a high-power load is deemed to consume more than 15 amperes.

Still preferably, the system comprises at least one emergency module which is electrically connected to the management module and to at least one emergency load, the energy management module being capable of indirectly powering the emergency load via the emergency module. Preferably, the emergency module also comprises a direct power supply using an emergency power source.

### BRIEF DESCRIPTION OF THE FIGURES

The invention will be better understood upon reading the following description, given purely by way of example and with reference to the accompanying drawings, in which:

FIG. 1 is a schematic view of an on-board energy management module which is electrically connected to power sources and to loads to be powered; and

FIG. 2 is another schematic view of a management module with auxiliary power supply modules and an emergency module.

It should be noted that the drawings present the invention in sufficient detail for it to be carried out, it being possible, of course, to use said drawings to better define the invention where necessary.

### DESCRIPTION OF ONE OR MORE EMBODIMENTS

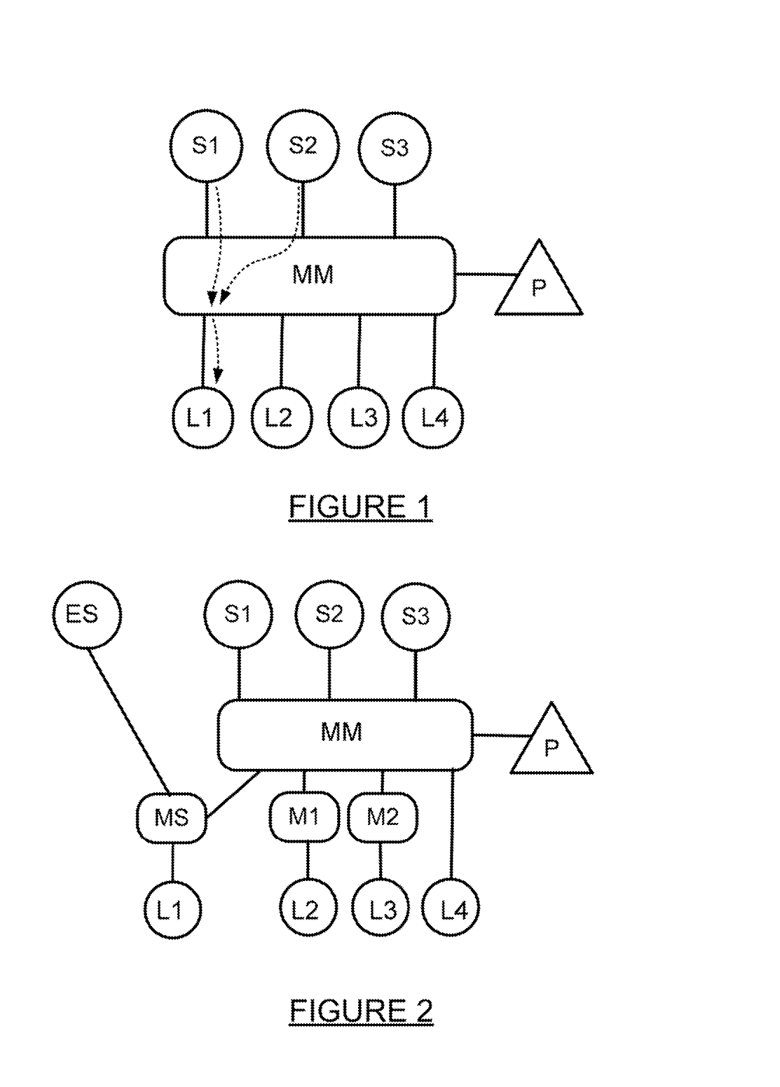

The invention will be presented with reference to FIG. 1 showing an aircraft comprising an electrical energy power supply system and a plurality of loads to be powered L1, L2, L3 and L4. The power supply system is equipped with a plurality of power sources S1, S2, S3.

The power sources S1, S2, S3 are different or the same in type and may be, for example, in the form of propulsion engine generators of the aircraft, of a, preferably engine-class, main power unit. It goes without saying that other types of power sources could be suitable.

Furthermore, the power sources S1, S2, S3 can supply electrical energy in the form of direct or alternating current, pneumatic energy in the form of compressed air, mechanical energy in the form of torque and power transmitted by a drive shaft. The storage of these energy types is provided by devices such as batteries or supercapacitors for electrical energy, pressure vessels for pneumatic energy and flywheels for mechanical energy.

As shown in the preamble of this application, a piece of aircraft equipment (mechanical actuators, flight controls, in-seat multimedia system for passengers, cabin ventilation etc.) is considered to be a load which consumes electrical, pneumatic or mechanical energy. In this example, four loads L1-L4 are shown in FIG. 1.

In order to allow an integrated management of the energy, whether it is electrical, pneumatic or mechanical in type, in the corresponding power supply system, the loads can be of two possible types: those that are referred to as “essential” loads which are important for the operation of the aircraft (flight controls etc.) and those that are referred to as “non-essential” loads which are less important for the operation of the aircraft (in-seat multimedia systems for passengers, cabin ventilation etc.). The loads are also divided according to the location at which they are installed to be powered by the closest power sources and to avoid, as far as possible, the loss of redundancy and/or functionally connected equipment.

According to the invention, with reference again to FIG. 1, the power supply system comprises an on-board energy management module having the reference MM, which is electrically connected to said power sources S1, S2, S3 and to said loads to be powered L1-L4.

The energy management module MM is in the form of an analogue computer comprising a memory in which is recorded a programme for managing the power sources S1, S2, S3 depending on the energy requirements of the loads to be powered L1-L4.

The energy management module MM is capable of controlling a power supply to at least one of said loads L1-L4 using at least two different power sources in parallel S1, S2, S3. In other words, a load is powered by two different power sources. This is referred to as a hybrid power supply of the loads of the aircraft. With reference to FIG. 1, the energy management module MM takes the energy from the sources S1 and S2 to the load L1 in order to power it.

Preferably, the energy management module MM uses a hybrid power supply of a load L1 when said load L1 requires an increasingly great amount of electrical energy which exceeds the capacity of the power source S1, which alone powers the load L1 during normal conditions of use.

Preferably, the management module MM comprises means (not shown in the drawings) for measuring power that are capable of measuring the power required by each, of the type current, voltage, flow measurement or torquemeter, for example. If the amount of power required exceeds a predetermined power threshold, the management MM commands another power source, in this case the source S2, to meet the requirements of the load L1.

The management module MM is capable of matching the requirements of loads L1-L4 with the energy supply of the power sources S1-S3 whilst limiting energy loss. By means of the method according to the invention, all of the loads are powered whilst avoiding excessive generation of energy, which would increase the fuel consumption of the aircraft. In other words, the management module MM allows the power supply of the loads to be adapted so as to improve the energy efficiency of the aircraft.

Preferably, the energy management module MM is stand-alone in order to connect specific power sources S1-S3 to specific loads L1-L4. Preferably, the management module MM comprises a database of specific rules which indicate several possible power supply configurations according to the state of the sources S1-S3 and the loads L1-L4. Thus, during operation, the management module MM analyses the current state of the sources S1-S3 and the loads L1-L4 and deduces therefrom the most suitable power supply configuration, using for example the configuration management tables which determine, firstly, which pieces of equipment are present and secondly, their consumption, nominal at each phase of the flight and maximum with the different scenarios of use.

In a first example of electrical energy management, the load L1 is powered by two sources of direct current S1, S2. According to this hypothesis, the direct currents from the sources S1-S2 are added together in a way that is known to a person skilled in the art.

In a second example of electrical energy management, the load L1 is powered by two sources of alternating current S1, S2. According to this hypothesis, the alternating currents from the sources are first converted into direct currents before being combined. For this purpose, the management module MM comprises AC/DC converters.

According to another hypothesis, the alternating currents from the sources are first synchronised before being combined in order to limit the phenomenon of coupling. Adding two sources of alternating current is considered to be unsuitable for aeronautical use due to the phenomenon of coupling. This is because the aeronautical domain requires stable and reliable power sources that are free of parasitic capacitance such as coupling. According to the invention, it is proposed to go against this preconception by providing optimal synchronisation of the sources to be combined in order to limit the losses during coupling. Advantageously, the management module MM comprises synchronisation means that are capable of conditioning an alternating current with the aim of adding it to another alternating current. The structure of a synchronisation system of this kind can be based on the frequency adaptation and by the phase of the alternating sources. The principle is to have the sources changed to the same frequency at first, then during the transition from one phase of one of the sources, to synchronise the other source. This allows the electrical losses to be reduced at the moment of coupling.

Advantageously, by means of the invention, if the load L1 is supplied with alternating current by the electrical power source S1 and requires an increasing amount of energy to function. The management module MM controls the source S2 so as to meet the requirements of the load L1. The alternating current of the source S2 is synchronised to that of the source S1 before being combined.

In a third example, the load L1 is powered by a source of direct current S1 at normal speed. If required, the management module MM commands a source of alternating current S2 to supply an additional direct current to the load L1 after conversion by an AC/DC converter of the management module MM.

According to an aspect of the invention, with reference to FIG. 1, the aircraft comprises means for storing energy, preferably an energy cell P. The management module MM is configured so as to power at least one of said loads L1-L4 using the means for storing energy P in the event of said load to be powered having an urgent energy requirement. These kinds of storage means P allow a one-off energy requirement of one of the loads L1-L4 to be met at short notice, when, for example, several pieces of equipment start up or activate at the same time.

With reference to FIG. 2, the power supply system comprises two auxiliary power supply modules M1, M2 which are electrically connected to the management module MM and to the loads L1-L4 in order to be able to adapt the energy supplied by the management module MM to the medium and low-power loads. In this example, as shown in FIG. 2, the energy management module MM directly powers the high-power load L4 and indirectly powers the low-power load L2 via the auxiliary power supply module M1 and the medium-power load L3 via the auxiliary power supply module M2. The high-power load L4 consumes a current of more than 15 A, in contrast with the loads L2 and L3.

Still preferably, the power supply system comprises at least one emergency module MS which is electrically connected to the management module and to at least one emergency load L1, the energy management module MM indirectly powering the emergency load via the emergency module MS. Preferably, the emergency module MS is also powered directly by an emergency source ES of the RAT (ram air turbine) type.

1. Method for supplying electrical energy to an aircraft having a plurality of loads to be powered and a power supply system, the power supply system being equipped with a plurality of power sources and an on-board energy management module, the method comprising: controlling, by the energy management module, a power supply to at least one of said loads using at least two different power sources in parallel in the event of increased energy requirements, said load initially being powered by a single power source.

2. System for supplying electrical energy to an aircraft that is equipped with a plurality of loads to be powered, said system comprising: a plurality of power sources and an on-board energy management module, the energy management module being electrically connected to said power sources and to said loads to be powered, wherein the energy management module is arranged so as to control a supply of power to at least one of said loads using at least two different power sources in parallel in the event of increased energy requirements, said load initially being powered by a single power source.

3. System according to claim 2, comprising means for storing energy, the energy management module being arranged so as to power at least one of said loads using said means for storing energy in the event of said load to be powered having an urgent energy requirement.

4. System according to claim 2, wherein said means for storing energy are in the form of an energy cell.

5. System according to claim 2, wherein said at least two sources are capable of supplying an alternating current to said at least one load.

6. System according to claim 2, wherein said at least two sources are capable of supplying a direct current to said at least one load.

7. System according to claim 2, wherein the energy management module is stand-alone.

8. System according to claim 2, wherein the energy management module is arranged so as to adapt the connections of the power sources according to the current consumed by the loads over time.

9. System according to claim 2, further comprising at least one auxiliary power supply module which is electrically connected to the energy management module and to said plurality of loads, the energy management module being capable of directly powering the high-power loads and indirectly powering the low and medium-power loads via said auxiliary power supply module.

10. System according to claim 2, comprising at least one emergency module which is electrically connected to the energy management module and to at least one emergency load, the energy management module being capable of indirectly powering the emergency load via the emergency module.
